(19) United States
(12) Patent Application Publication
(10) Pub. No.: US 2010/0012208 A1
(43) Pub. Date: Jan. 21, 2010

(54) WATER-SAVING DEVICE WITH LIGHTING EFFECT

(75) Inventor: TSUNG-TSE CHUANG, Taipei (TW)

Correspondence Address: WPAT, PC;INTELLECTUAL PROPERTY ATTORNEYS, 7225 BEVERLY ST., ANNANDALE, VA, 22003, US

(73) Assignee: TSUNG-TSE CHUAGE, Taipei (TW)

(21) Appl. No.: 12/173,629

(22) Filed: Jul. 15, 2008

(51) Int. Cl. F16K 21/00

(52) U.S. Cl. 137/801

(57) ABSTRACT

A water-saving device with lighting effect includes a main body for installing on a spout of a faucet. A pressure valve and a light holder are respectively fixed in upper and lower ends of an internally threaded through bore of the main body. A light-emitting element is held in the light holder. When the faucet is turned open, water flow impacts on the pressure valve to force the pressure valve downward and electrically connect the light-emitting element to a battery, bringing the light-emitting element to emit color light for the water flow to show color, too. In addition, the pressure valve and the light holder reduce the spout to thereby slow down water flow and achieve the purpose of water saving.

### FIELD OF THE INVENTION

The present invention relates to a water-saving device with lighting effect, and more particularly to a water-saving device for mounting to a faucet and provided with a light-emitting element. When the faucet is turned open, the light-emitting element emits color light through the water flow, making washing more interesting.

### BACKGROUND OF THE INVENTION

A conventional faucet has a controlling lever, which can be rotated or lifted to control water flow. It often takes place that the controlling lever is overly shifted and an excessively large amount of water instantaneously rushes out of the faucet to splash on a user's clothes. This not only embarrasses the user, but also causes waste of water. To solve this problem and meet the concept of environmental protection, all countries on the world have established policies for saving water resource. In response to the water saving policies, various types of water-saving devices have been developed, such as an aerator for mounting to a spout of the faucet.

A conventional aerator for faucet includes a metal case, a filtering net mounted in an upper end of the metal case, a water-saving pad, and a metal screen arranged at a bottom of the metal case. The filtering net has a plurality of tiny holes. When passing through the water-saving pad and the metal screen, water flow is split into a plurality of not fully continuous small water streams. Accordingly, the amount of water flowing out of the faucet is reduced to save water. Moreover, the water flow is slowed down to avoid splash of water.

On the other hand, there are fountains provided with color lights to give color to water streams ejected from the fountains, making the fountains more attractive.

It is therefore tried by the inventor to develop a water-saving device with lighting effect, so that water flowing out of a faucet is not only reduced in amount, but also colored.

### SUMMARY OF THE INVENTION

A primary object of the present invention is to provide a water-saving device with lighting effect for mounting to a faucet, such that when the faucet is turned open, the water-saving device projects color light through water flow, making washing more interesting.

Another object of the present invention is to provide a water-saving device, which is able to slow down water flow and reduce the amount of water being released, so as to achieve the purpose of water saving.

To achieve the above and other objects, the water-saving device with lighting effect according to the present invention includes a main body for installing on a spout of a faucet. A pressure valve and a light holder are respectively fixed in upper and lower ends of an internally threaded through bore of the main body. A light-emitting element is held in the light holder. When the faucet is turned open, water flow impacts on the pressure valve to force the pressure valve downward and electrically connect the light-emitting element to a battery, bringing the light-emitting element to emit color light for the water flow to show color, too. In addition, the pressure valve and the light holder reduce the spout to thereby slow down water flow and achieve the purpose of water saving.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of a water-saving device according to an embodiment of the present invention;

FIG. 2 is an exploded perspective view of FIG. 1;

FIG. 3 is an assembled sectional view of the water-saving device of FIG. 1;

FIG. 4 is an assembled sectional view showing the water-saving device of FIG. 1 is mounted to a spout of a faucet;

FIG. 5 is an assembled sectional view showing that a pressure valve of the water-saving device of the present invention is forced downward by water flow to thereby close a lighting circuit of the water-saving device; and

FIG. 6 is an assembled sectional view showing the water-saving device of the present invention is installed on an internally threaded spout of a faucet.

### DETAILED DESCRIPTION OF THE PREFERRED EMBODIMENTS

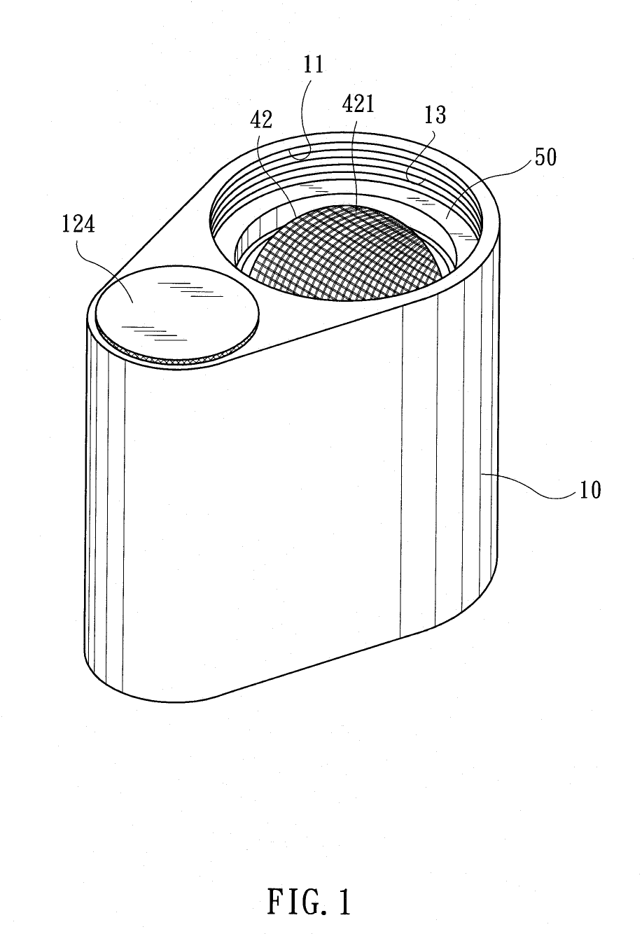

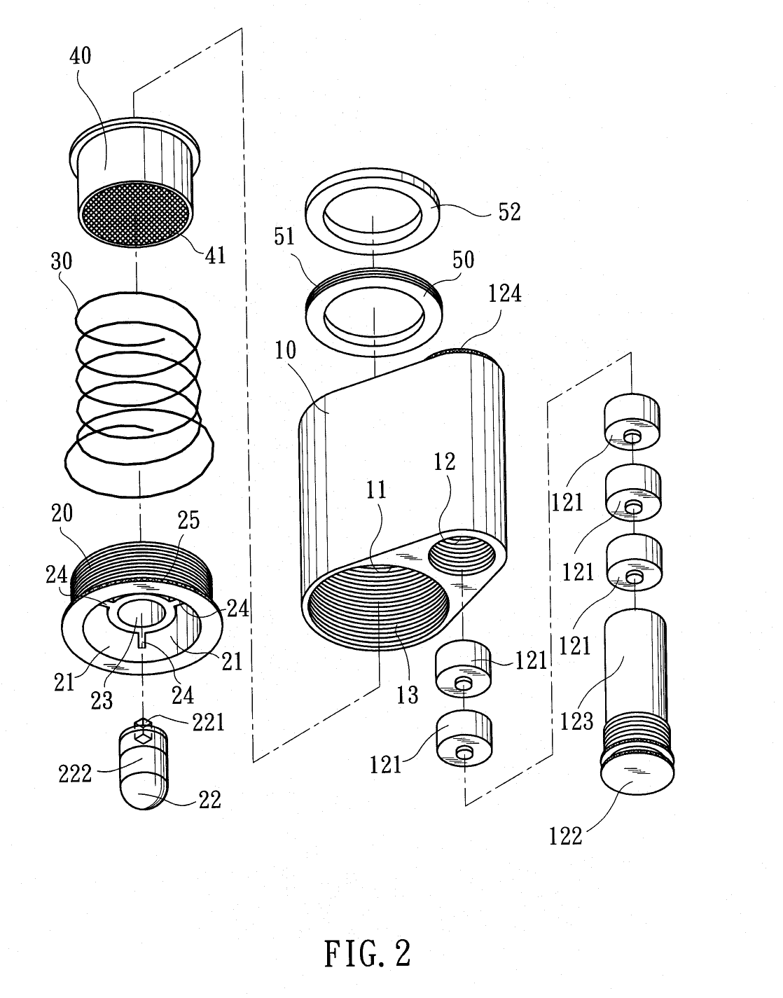

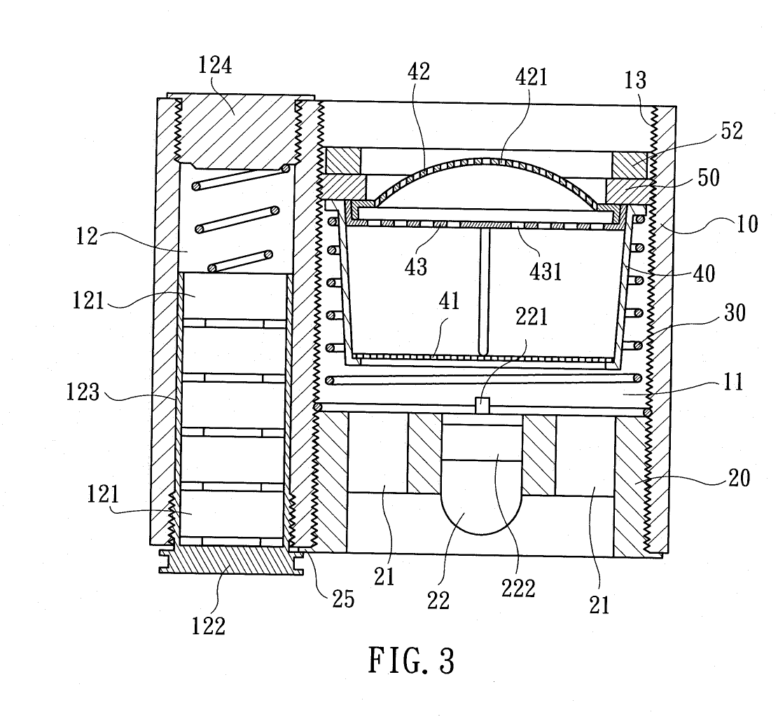

Please refer to FIGS. 1, 2 and 3, in which a water-saving device with lighting effect according to a first embodiment of the present invention is shown. As shown, the water-saving device of the present invention is configured for installing on a spout of a faucet, and includes a main body 10, a light holder 20, a pressure valve 40, a retainer ring 50, and a compression spring 30.

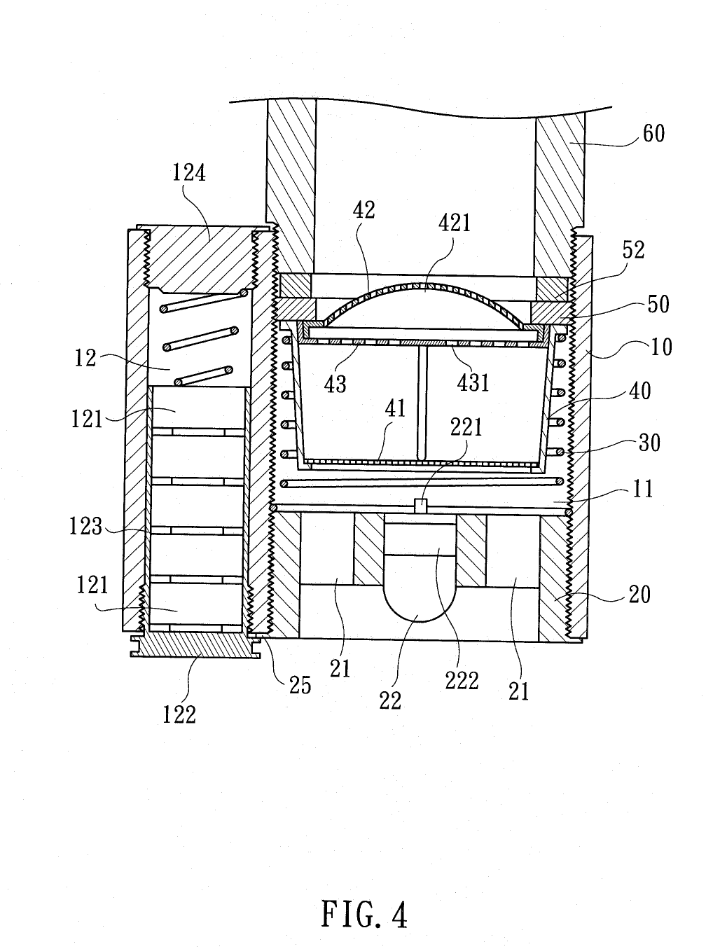

The main body 10 is provided with a through bore 11 extended from an upper end to a lower end of the main body 10, and a battery compartment 12. An inner wall surface of the through bore 11 is provided with threads 13 for screwing to an externally threaded faucet spout 60, as shown in FIG. 4. The battery compartment 12 has a bottom opening openably closed with a cap 122, so that a plurality of serially connected batteries 121 can be positioned into the battery compartment 12 via the bottom opening. An inner end of the cap 122 is formed into a sleeve 123, in which the batteries 121 are positioned and stable supported, so that the batteries 121 would not drop when the cap 122 is loosened from the battery compartment 12 for replacing the batteries 121.

When the main body 10 is made of an extruded aluminum material, the battery compartment 12 may also have an open top sealed with another cap 124, which is in contact with a negative electrode of the batteries 121.

The light holder 20 is provided with at least one axially extended through hole 21, and has at least one light-emitting element 22 mounted thereto. The light-emitting element 22 has an upward protruded first contact 221 to serve as a power input, and a second contact 222 arranged around the light-emitting element 22 for contacting with the light holder 20. In the illustrated embodiment of the present invention, the light holder 20 has an annular wall and a centered collar 23 for holding the light-emitting element 22 therein. The collar 23 is integrally connected to the annular wall of the light holder 20 via three spaced ribs 24 radially extended between the collar 23 and the annular wall, such that a through hole 21 is formed between any two adjacent ribs 24. The light holder 20 is externally threaded for screwing into and thereby fixing in a lower end of the internally threaded through bore 11 on the main body 10. The light holder 20 is also provided around a lower end with a radially outward extended flange 25, which has an outer diameter larger than an inner diameter of the through bore 11 of the main body 10. When the flange 25 is abutted on a bottom of the main body 10, it indicates that the light holder 20 has been fully screwed into the through bore 11 and positioned in place.

The pressure valve 40 is a hollow tubular body made of a metal material. The pressure valve 40 is positioned in the through bore 11 of the main body 10 above the light holder 20. A metal screen 41 is disposed on a bottom of the pressure valve 40, and a filter 42 with a plurality of tiny holes 421 is disposed at an upper end of the pressure valve 40. A water-saving pad 43 formed with a plurality of apertures 431 is disposed in the pressure valve 40 below the filter 42, limiting water to flow through only the apertures 431 to achieve the purpose of saving water. The pressure valve 40 has an internal structure similar to that of the conventional aerator, except that the valve pressure employed in the present invention is movably relative to the spout, and would therefore move downward when being impact by water flow.

The retainer ring 50 is fixed in the through bore 11 of the main body 10 above the upper end of the pressure valve 40 to define an allowable highest position of the pressure valve 40 in the through bore 11. The retainer ring 50 is externally formed with threads 51 for screwing into the internally threaded through bore 11 of the main body 10 and thereby being fixed therein.

The compression spring 30 is positioned between the light holder 20 and the pressure valve 40 to normally elastically lift the pressure valve 40 to the highest position defined by the retainer ring 50, so that the metal screen 41 at the bottom of the pressure valve 40 is separated from the first contact 221 of the light-emitting element 22. The upper end of the pressure valve 40 has an increased outer diameter to press against an upper end of the compression spring 30. A lower end of the compression spring 30 has an increased outer diameter for tightly engage with one of the threads 13 formed in the through bore 11 of the main body 10, so that the compression spring 30 is always electrically connected to the main body 10. Meanwhile, the compression spring 30 is also electrically connected to the pressure valve 40.

The light holder 20 may be made of an extruded aluminum material. The light holder 20 is anodized so that its surfaces are electrically nonconductive. Only an inner wall surface of the collar 23 and a bottom of the flange 25 are polished to thereby become electrically conductive. The main body 10 may be made of an extruded aluminum material and is anodized to have electrically nonconductive outer surfaces. While the cap 122 closes the bottom opening of the battery compartment 12, the cap 122 also presses against a portion of the bottom of the flange 25 provided around the lower end of the light holder 20, allowing the second contact 222 of the light-emitting element 22 to electrically connect to a positive electrode of the batteries 121.

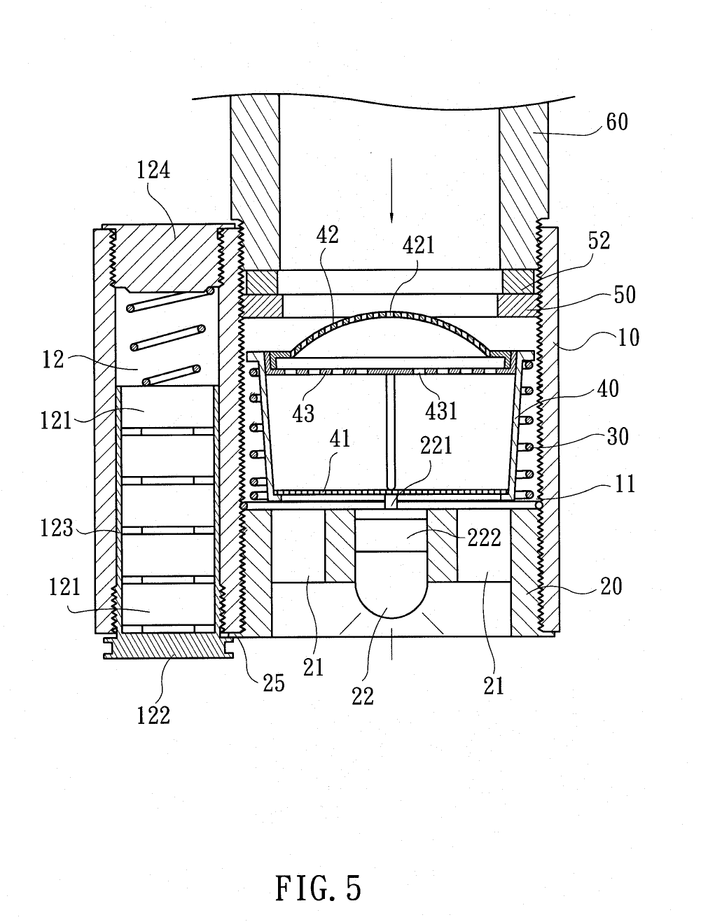

Please refer to FIG. 5. To install the main body 10 on a spout 60 of a faucet (not shown), a watertight sealing ring 52 is mounted on a top of the retainer ring 50 to prevent water from overflowing the main body 10. When the spout 60 is externally threaded, the main body 10 can be directly screwed to the spout 60 for use. When the faucet is turned open, water flowing out or the spout 60 will impact on the pressure valve 40 and force the pressure valve 40 downward, bringing the metal screen 41 at the bottom of the pressure valve 40 to touch the upward protruded first contact 221 of the light-emitting element 22. At this point, a circuit between the batteries 121 and the light-emitting element 22 is closed, bringing the light-emitting element 22 to emit light as shown in FIG. 5.

When the water-saving device of the present invention is in use, the tiny holes 421 on the filter 42, the apertures 431 on the water-saving pad 43, and meshes on the metal screen 41 allow water to flow through the pressure valve 40. In addition, the filter 42, the water-saving pad 43, and the metal screen 41 provide the function of slowing down the water flow and splitting the water flow into a plurality of small streams to enable a first stage of water saving. When flowing through the light holder 20, the water flow is further slowed down to enable a second stage of water saving. Moreover, since the water flow is slowed down, the impact of the water flow against a sink is reduced to avoid splash of water.

Preferably, the light-emitting element 22 is a light emitting diode (LED) emitting color light. The color light emitted from the light-emitting element 22 is projected through the water flowing through the main body 10 to show colored water flow, making washing more interesting.

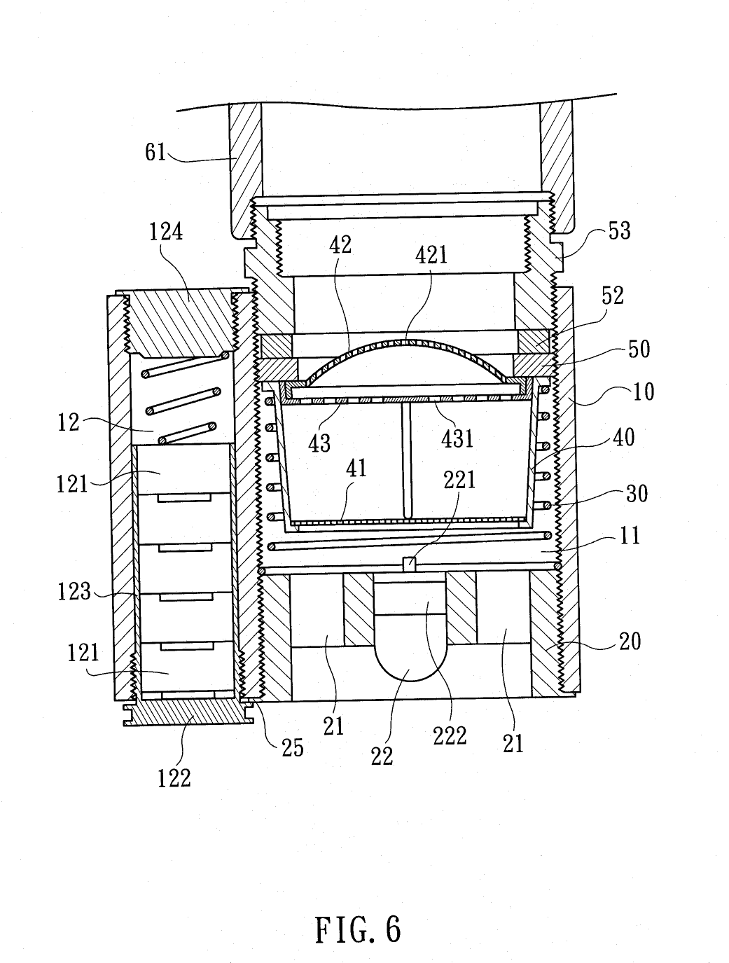

When the spout 60 of the commercially available faucet is externally threaded as that shown in FIG. 4, the main body 10 can be directly screwed onto the spout 60 of the faucet. However, in the case of an internally threaded spout 61 as that shown in FIG. 6, an externally threaded tubular adapter 53 is needed for meshing with the internally threaded spout 61. When installing, an upper end of the tubular adapter 53 is screwed to the internally threaded faucet spout 61 while a lower end of the tubular adapter 53 is screwed to the main body 10.

The water-saving device with lighting effect according to the present invention is novel and practical for use because it not only provides water saving effect, but also projects color light to create fun in using water.

What is claimed is:

1. A water-saving device with lighting effect, comprising:
a main body having a through bore extended from an upper end to a lower end of the main body and provided on an inner wall surface with threads, and a battery compartment having a bottom opening, via which a plurality of batteries may be positioned into the battery compartment; a cap being provided for openably closing the bottom opening of the battery compartment; and the main body being anodized to have non-conductive outer surfaces;
a light holder being fixed in the internally threaded through hole of the main body, and having a plurality of axially extended through holes formed thereon; at least one light-emitting element being held in the light holder with a first contact upward protruded from a power input of the light-emitting element and a second contact electrically connected to the light holder; the light holder being provided around a lower end with a radially outward extended flange, which is in contact with the cap closing the bottom opening of the battery compartment on the main body;
a pressure valve in the form of a metal-made tubular body being mounted in the internally threaded through bore of the main body above the light holder; a filter being mounted to a top of the pressure valve, and a metal screen being mounted to a bottom of the pressure valve;
a retainer ring fixed in the internally threaded through bore of the main body to locate above the top of the pressure valve; and
a compression spring positioned between the light holder and the pressure valve for normally elastically lifting the pressure valve, so that the metal screen at the bottom of the pressure valve is separated from the first contact of the light-emitting element; and the compression spring being kept in contact with the inner wall surface of the internally threaded through bore of the main body.

2. The water-saving device with lighting effect as claimed in claim 1, wherein the light holder includes at least one axially extended collar, in which the light-emitting element is fixedly held.

3. The water-saving device with lighting effect as claimed in claim 2, wherein the light holder is anodized to have electrically nonconductive surfaces, except for an inner surface of the collar and a bottom of the flange that are polished to become electrically conductive.

4. The water-saving device with lighting effect as claimed in claim 1, wherein the compression spring has an expanded lower end for engaging with one of the threads formed on the inner wall surface of the internally threaded through bore.

5. The water-saving device with lighting effect as claimed in claim 1, wherein the pressure valve further includes a water-saving pad disposed below the filter, and the water-saving pad being formed with a plurality of apertures.

6. The water-saving device with lighting effect as claimed in claim 1, wherein the upper end of the pressure valve has an upper end with an increased outer diameter for pressing against an upper end of the compression spring.

7. The water-saving device with lighting effect as claimed in claim 1, wherein an inner end of the cap closing the bottom opening of the battery compartment is formed into a sleeve, in which the batteries are positioned and stably supported.

8. The water-saving device with lighting effect as claimed in claim 1, further comprising an externally threaded tubular adapter having a lower end for screwed into the upper end of the internally threaded through bore of the main body, and an upper end with external threads for screwing into an internally threaded faucet.
